(19) United States
(12) Patent Application Publication
(10) Pub. No.: US 2008/0134434 A1
(43) Pub. Date: Jun. 12, 2008

(54) Holistic face-down recovery apparatus and method therefor

(76) Inventor: Paul J. Celauro, Ocala, FL (US)

Correspondence Address: ROCKEY, DEPKE & LYONS, LLC, SEARS TOWER, SUITE 5450, CHICAGO, IL, 60606-6306, US

(21) Appl. No.: 11/977,601

(22) Filed: Oct. 25, 2007

Related U.S. Application Data
(60) Provisional application No. 60/854,376, filed on Oct. 25, 2006.

(51) Int. Cl. A61G 7/005

(52) U.S. Cl. 5/610

(57) ABSTRACT

A face-down recovery apparatus for use in rehabilitation of patients, particularly vitreoretinal surgical patients. The apparatus has a base and a housing that is pivotally connected to the base by an actuator. A support is positioned contiguously on the housing for received a user in a face-down position. The apparatus is moveable between a substantially vertical, upright orientation to a substantially horizontal orientation. The apparatus is in a substantially upright vertical orientation when the support receives a user in a standing position. The face of a user is secured in a face-down position in a face support, and the rest of the user is secured to the support in a standing position in an unrestricted manner permitting mobility. As the housing is tilted into a horizontal position, the user is positioned in a substantially horizontal orientation. As the user is tilted between the substantially vertical upright orientation and the substantially horizontal orientation, the user's face is continuously maintained in a face-down position in the face support.

### CROSS-REFERENCE TO RELATED APPLICATIONS

The present application claims priority to and the benefit of U.S. Provisional Application No. 60/854,376, filed on Oct. 25, 2006, and is incorporated by reference and made a part hereof.

### TECHNICAL FIELD

The present invention relates generally to a method and apparatus for use in rehabilitation of surgical patients, and more particularly for the rehabilitation of vitreoretinal surgical patients.

### BACKGROUND OF THE INVENTION

Vitreoretinal surgery, repair to the rear-most wall of the eye, is commonly used to treat diabetic retinopathy, vitreous hemorrhage, hemolytic glaucoma, central vein occlusion, and macular holes/tears. Post-vitreoretinal surgery requires patients to remain face-down for extended periods of time to ensure proper healing. The macula is a small part of the retina that is responsible for clear vision. A tear or hole in the macular membrane causes the loss of central vision. Surgery consists of removing the vitreous humor, the jelly-like substance that fills the inner eye, so the surgeon can repair the damaged portion. The empty cavity is replaced with a gas bubble. Since gas rises, and the surgery takes place in the back of the eye, recovering patients must remain face-down in order for the hole to be filled with the gas bubble, keeping contact with the macula. It is imperative that patients remain in a face-down position 24 hours a day, over a period of 2-6 weeks.

Ophthalmologists agree that the single greatest contributor to successful, complete recovery from vitreoretinal surgery is a patient's adherence to the regimen of maintaining the face-down position for the prescribed period of time. This yields the best results in macula re-bonding to the eye wall, allowing gradual replacement of the gas bubble by newly generated vitreous humor.

The postoperative face-down position can be extremely challenging for a patient. Patients face hours of monotony, stress, discomfort, as well as atrophy of major muscle groups. The potential negative side-effects of face-down recovery are numerous. After a short period of time patients may experience stiffness of the neck and back, nasal congestion, facial swelling, and pressure points on the face. These are all common results of resting the head in one position. Extremities may grow numb because of lack of movement. Sleeping on the stomach is also difficult because the head must be turned sideways to allow adequate breathing. During face-down recovery the patient's lifestyle is restricted to minimal movement. Entertainment and other stimulation are limited by the physical constraints of currently available recovery apparatus.

Vitreoretinal surgery recovery apparatus are known, however, the current systems are restrictive in many ways. A seated support system is available having a face-down chair angled to alleviate possible stress on the back, in which the patient sits or kneels in the device. Some sitting systems offer support for the knees. However, none of these systems allow for exercise of the legs and arms. Other systems offer a face support system attached to a bed or table. In such a system, the patient is also restricted to any kind of mobility, and is therefore not comfortable. Also available are face-down pillows and face-down mirrors.

There is a need for a face-down recovery apparatus that adequately supports and maintains a patient's face in a fixed face-down position during recovery while permitting mobility of the rest of the body. Since the weight of the recovering patient's head must be supported adequately for long periods, there is a need for an apparatus having adequate clearance and space for breathing freely without forming dead captive spaces to harbor stale air. There is further a need for a face-down recovery apparatus that provides a built-in entertainment and/or exercise device. The present invention is directed to a recovery apparatus that encourages patients to maintain the proper face-down recovery position for the duration of the prescribed recovery period so that optimal recovery results are achieved. The present invention allows patients to proactively pursue mental, sensory, and physical activities thereby circumventing the negative side-effects of boredom, muscle atrophy and immobility. Thus, the present invention encourages exercise, rest, stress release, and creativity in order to bring the body, mind, and emotions into balance, hence, a holistic approach to healing. This holistic approach to the healing process enhances a patient's ability and personal desire to follow a physician's prescribed recovery regimen.

### SUMMARY OF THE INVENTION

The present invention provides for a face-down recovery apparatus for post-vitreoretinal surgery. The apparatus of the present invention optimizes a patient's recovery regimen by maximizing comfort and encouraging exercise and stress release.

According to one aspect of the present invention, an apparatus is provided for face-down recovery of post-surgical patients. According to a first aspect of the present invention, the apparatus has a base, a housing pivotally connected to the base, and an actuator coupled between the housing and the base. The actuator has a first end pivotally connected to the base and a second end pivotally connected to the housing. A support is contiguously connected to a first side of the housing for receiving a user. The apparatus is moveable between a substantially upright vertical orientation to a substantially horizontal orientation. When the apparatus is in a substantially vertical upright orientation the support receives and secures the user to the support in the standing position in an unrestricted manner permitting mobility. As the housing is tilted, the user is positioned into a substantially horizontal orientation. In the preferred embodiment, as the user is tilted between the vertical upright and the horizontal orientations, the user's face is continuously maintained in a face support in a face-down position.

According to another aspect of the present invention, the face support area may contain a silent slow speed ventilator for continuously circulating and refreshing the air in and around the face support area with fresh air from the surroundings.

According to another aspect of the present invention, a transmission is located within the housing that is operably coupled to the actuator to control tilting and undulation movements of the apparatus. Such undulation movements may be intermittent and/or continuous. Furthermore, the apparatus may be tilted at any desired angle.

According to a further aspect of the present invention, a foot pedal assembly and a hand pedal assembly are attached to the housing permitting the user to exercise while in the face down position.

A further aspect of the present invention is a media center attached to a portion of the housing, in which the media center comprises a computer, an audio CD player, a video player, a DVD player, a computer, a television, or mp3 player. The media center is available for educational, entertainment, and therapeutic purposes to the user during the recovery process.

### DESCRIPTION OF THE DRAWINGS

To understand the present invention, it will now be described by way of example, with reference to the accompanying drawings in which:

FIG. 1 is a side view of a user in a face-down position in accord with the present invention;

FIG. 2 is a side view of a user in a face-down position in accord with the present invention;

FIG. 3 is a side view of a user in a face-down position in accord with the present invention;

FIG. 4 is a side view of a user in a face-down position in accord with the present invention;

FIG. 5 is a side view of a user in a face-down position in accord with the present invention;

FIG. 6 is a side view of a user in a face-down position in accord with the present invention;

FIG. 7 is a side view of a user in a face-down position in accord with the present invention;

FIG. 8 is a side view of a user in a face-down position in accord with the present invention;

FIG. 9 is a side view of a chain idler assembly of the present invention;

FIG. 10 is a side view of the apparatus in a substantially horizontal orientation;

FIG. 11 is a side view of the apparatus in a substantially tilted orientation;

FIG. 12 is a side view of the apparatus in a substantially vertical orientation;

FIG. 13 is a side view of the apparatus in a substantially horizontal orientation;

FIG. 14 is a side view of a transmission of the present invention;

FIG. 15 is a side view of a transmission of the present invention;

FIG. 16 is a side view of a user in a face-down position in accord with the present invention showing undulating movements;

FIG. 17 is a side view of a user in a face-down position in accord with the present invention showing undulating movements;

FIG. 18 is a side view of a user in a face-down position in accord with the present invention showing undulating movements;

FIG. 19 is a side view of a user in a face-down position in accord with the present invention showing undulating movements;

FIG. 20 is a side view of a user in a face-down position in a substantially vertical orientation;

FIG. 21 is a side view of a user in a face-down position in a substantially horizontal orientation;

FIG. 22 is a side view of a transmission of the present invention;

FIG. 23 a rear view of a transmission of the present invention;

FIG. 24 is a side view of a transmission of the present invention;

FIG. 25 is a side view of a foot support of the present invention; and

FIG. 26 is a side view of a pedal assembly of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

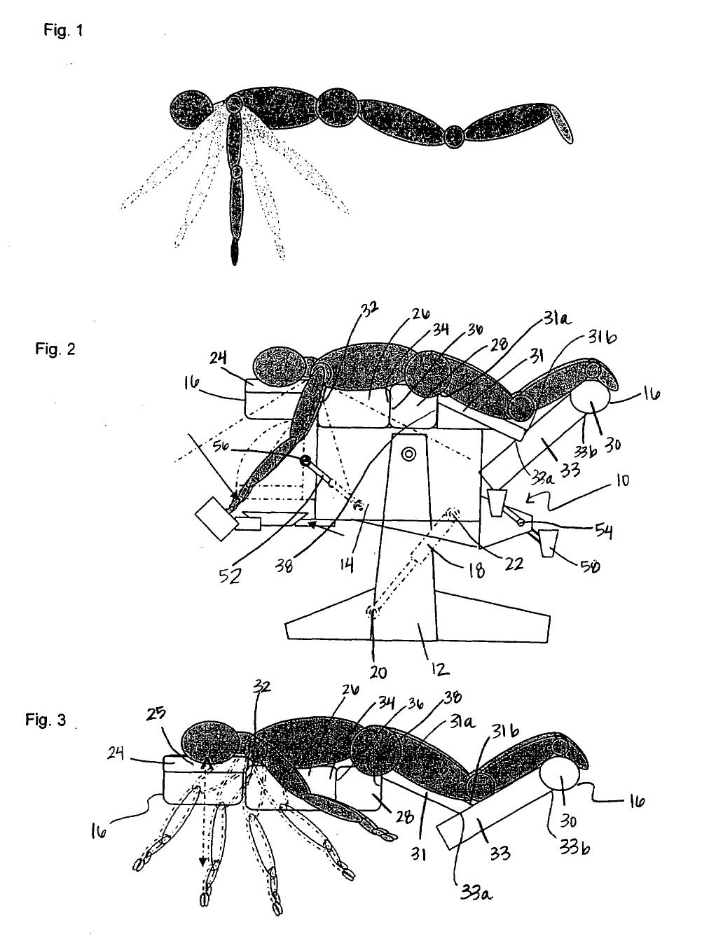

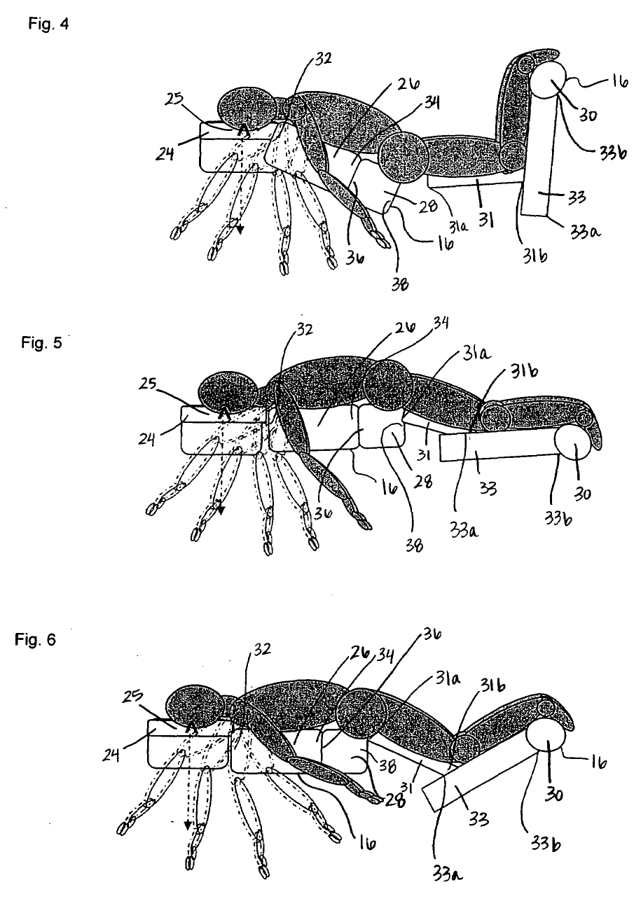

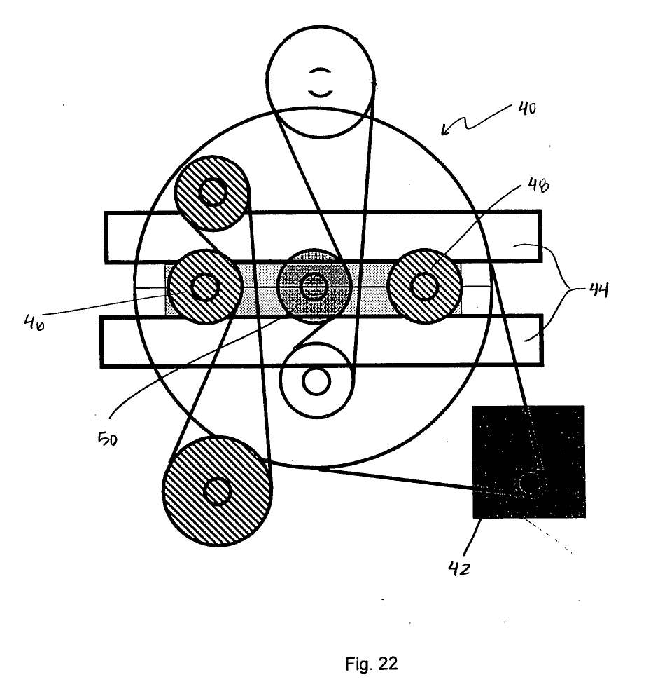

FIGS. 1-26 show the face-down recovery apparatus of the present invention, generally designated with reference numeral 10. The recovery apparatus is designed to maintain a patient or user's head firmly in a face-down position, with the patient's eyes focused perpendicular to the floor, while the rest of the body is sufficiently supported to alleviate strain from the patient's joints, back, legs and arms.

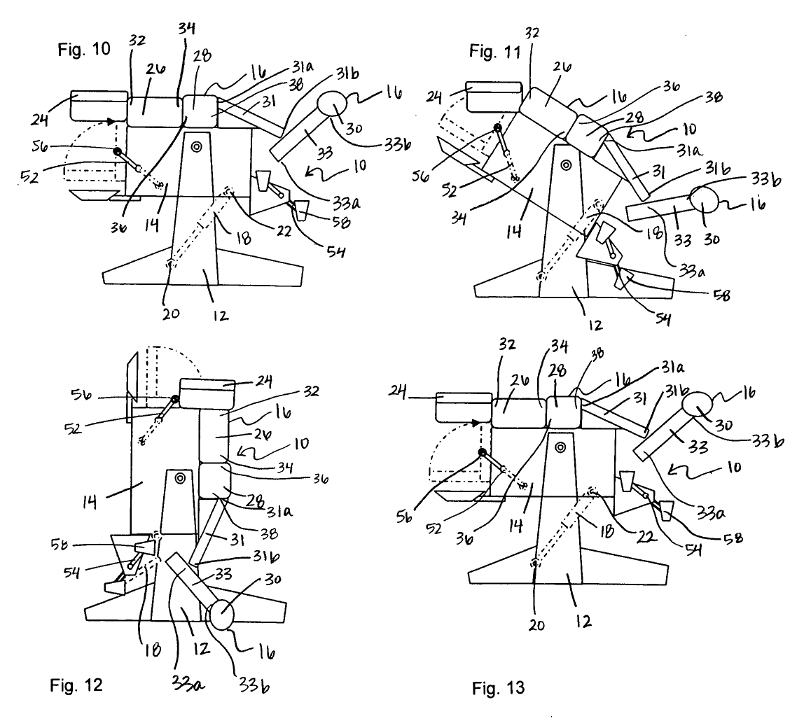

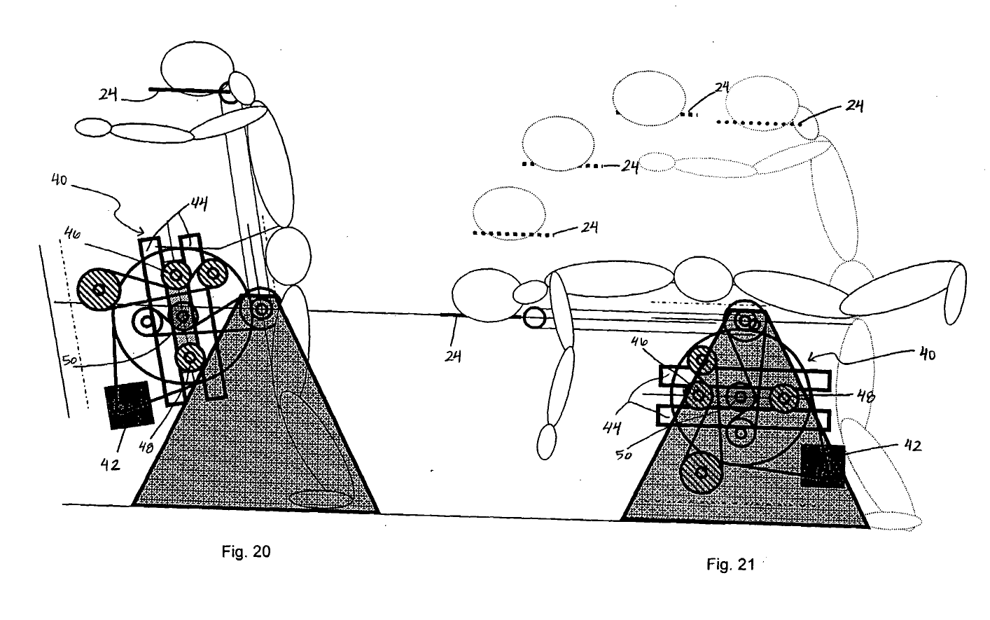

As shown in FIGS. 2 and 8, the recovery apparatus 10 generally has a base 12, a housing 14, and a support 16. FIG. 2 shows the housing 14 connected to the base 12 by an actuator 18. The actuator 18 has a first end 20 pivotally connected to the base 12, and a second end 22 pivotally connected to the housing 14. The actuator 18 tilts the entire apparatus 10 from a substantially horizontal position to a substantially vertical position as shown in FIGS. 10-13, thereby providing easy walk-on access. In an alternative embodiment, the recovery apparatus 10 may be adjusted to various desired angles to accommodate each individual as shown in FIGS. 11 and 20.

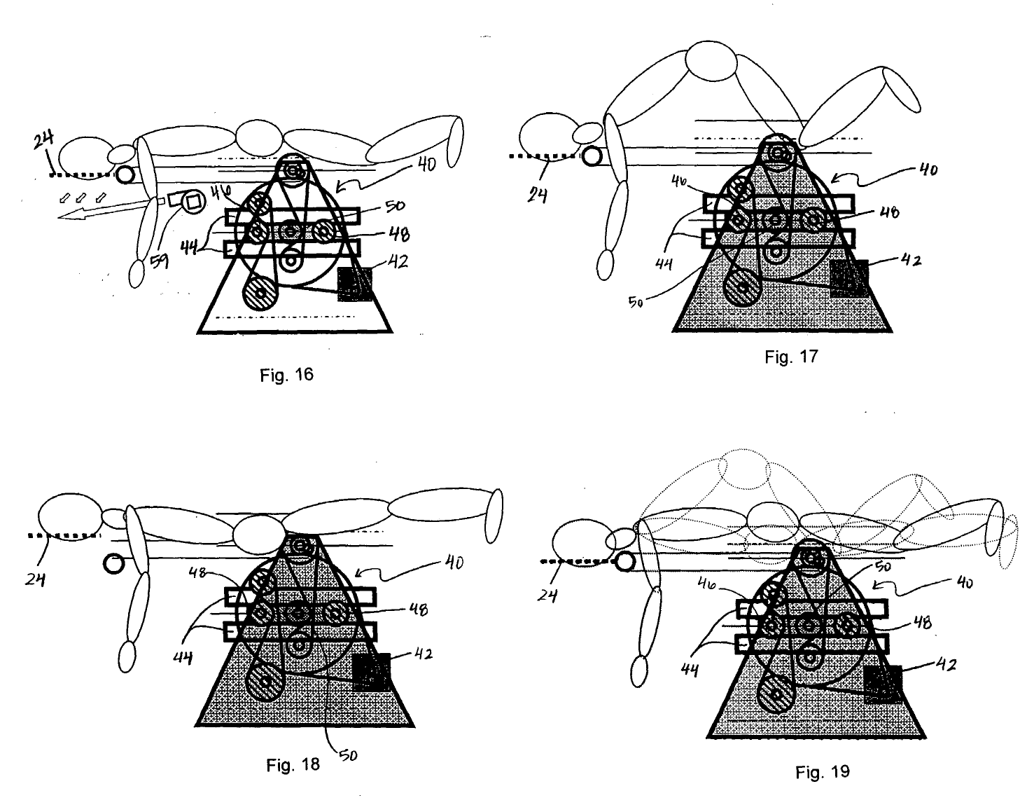

The support 16 of the recovery apparatus 10, is contiguously connected to the housing 14, as shown in FIGS. 2 and 8. The support 16 operates to receive a patient in the face-down position, and is adjustable to receive patients from about 4′9″ to about 7′ in height. The support comprises a face support 24, an upper torso support 26, a lower torso support 28, and a foot support 30, which are operably connected to one another, and independently adjustable, to permit smooth continuous movements, or undulation movements, of key joints and muscle groups while a patient remains in the face-down position as depicted in FIGS. 16-19. The undulation movements are proportionally adjusted according to the height of a patient. As shown in FIG. 2, the face support 24 is coupled to a first end 32 of the upper torso support 26. A second end 34 of the upper torso support 26 is pivotally connected to a first end 36 of the lower torso support 28. The present invention significantly alleviates stress at critical joints such as the neck, arms, shoulders, pelvis, legs, and feet through selectable continuous or intermittent undulation movements. Each portion of the support 16 is padded using materials known in the art for added comfort. For example, cushioning, such as but not limited to memory foam, may be used to adjust to the size and contours of the body of the patient. Furthermore, the cushions may utilize washable cotton covers or disposable covers to ensure cleanliness.

FIGS. 2 and 3 depict a first bracket 31, having a first end 31a and a second end 31b, the first end 31a is connected to a second end 38 of the lower torso support 28. FIGS. 2 and 3 also shows a second bracket 33, having a first end 33a and a second end 33b, the first end 33a is connected to the second end 31b of the first bracket 31, and the second end 33b is connected to the foot support 30. The brackets 31 and 33 are ergonomically positioned in a manner to allow a user to optionally engage his or her feet onto the foot support 30, while the rest of the user's torso is adequately supported by the torso supports 26 and 28.

As shown in FIGS. 3-7, the face support 24 has an aperture 25 for receiving and securing a patient's face in a comfortable face-down position. A significant advantage of the present invention is the ability of the face support 24 to maintain a patient's face in a substantially horizontal face-down position when the patient is moved from a substantially vertical standing orientation to the horizontal face-down position, as shown in FIGS. 10-13 and 21-26. This is achieved via a drive-chain cantilevered movement between the face support 24 and a fixed pivot shaft keyed to the top of side of the support 16, in which the roller drive chain and sprockets are oriented to maintain parallel positions by fixing one sprocket and driving the other. As such, the adjustable face support 24, continuously promotes the face-down regimen by maintaining a patient's face parallel to the floor despite the motion of the apparatus 10.

The apparatus 10 of the present invention is designed to be either stationary or portable. In one embodiment of the present invention, a pair of wheels Y are mounted to the bottom of the base 12 to allow easy wheeling as a two wheel hand truck. Alternatively, a second pair of wheels can be mounted to the base resulting in a four-wheel dolly. The apparatus 10 may be contracted to a transport width of about 68.58 centimeters (about 27 inches), allowing easy passage through narrow doorways that are typically about 76.2 centimeters (about 30 inches) wide in a residential bedroom door. The apparatus 10 easily expands to about 91.44 centimeters (about 36 inches) in width, for stability, once the unit is placed in the position in which it will be used. Self-recessing wheels and convenient lift handles allow easy movement and handling of the apparatus from room to room, or from a delivery vehicle to a home or upstairs. The apparatus 10 is intended to be easily handled by one person, or two if dealing with stairs or lifts.

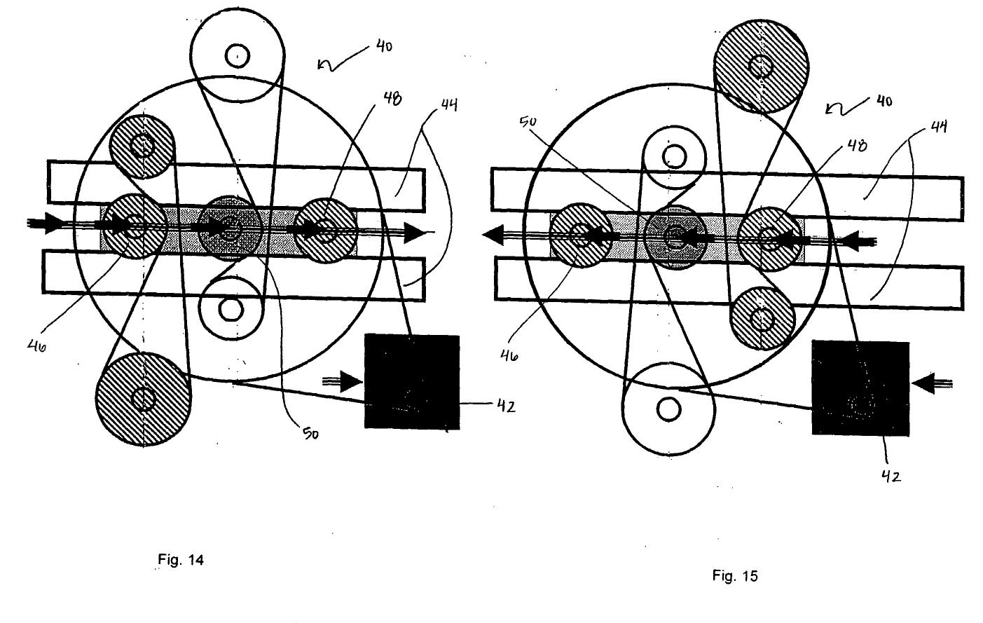

FIGS. 16-21 show the interior of the housing 14 in which the transmission 40 is housed. The transmission 40 controls the tilting movements of the apparatus 10, as well as the undulation movements of the support 16. The control mechanisms for tilting the apparatus may be integrally connected to the controls for undulation movements. Having the undulations being driven by the same reduction train and the shifting mechanism provides an intrinsic mechanical interlock, preventing the apparatus from operating in both modes at the same time. FIGS. 14, 15, 22 and 24 show the transmission 40 having a motor 42, a two-position internal sprocket rack 44, a first static sprocket 46, a second static sprocket 48 and a motor driven motive sprocket 50 to drive separate reduction sprocket systems to perform tilting and undulation motions. In another embodiment, the tilting mechanism is motor operated by a lead screw mechanism and/or a hydraulics mechanism. In either embodiment, the apparatus 10 can be tilted from a substantially vertical position to a substantially horizontal position in about 12-15 seconds. In order to provide an environment of relaxation, slow, steady and smooth motions are achieved though liberal use of UHMW (Ultra High Molecular Weight Polyethylene) block-to-metal shaft or pin motion bearings throughout the apparatus 10, low rotational and linear velocities, as well as liberal applications of noise and vibration reducing techniques. For example, in one embodiment, automated motion tasks are performed by a single parallel-shaft induction 1/9 HP gear motor with a reduction ratio of 40:1 and an output shaft speed of 43 RPM to keep all rotational shafts driven by gear motor operating at very low relative speeds, eliminating engagement noise of sprocket teeth on drive chains, and rotational whine on shafts, cams and bearings.

The motor 42 is enclosed in an acoustic enclosure with a low-frequency tuning factor for a mid-frequency motor. The motor 42 is also mounted in acoustically optimized motor mounts to further reduce motor noise and vibration transmission of the apparatus, thereby reducing stress of the recovering patient.

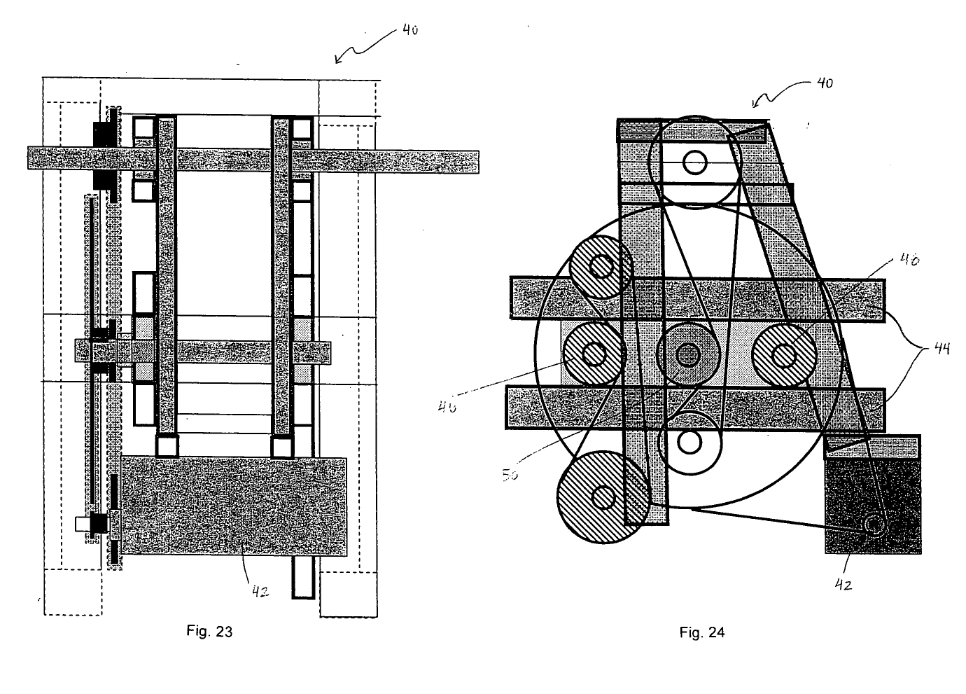

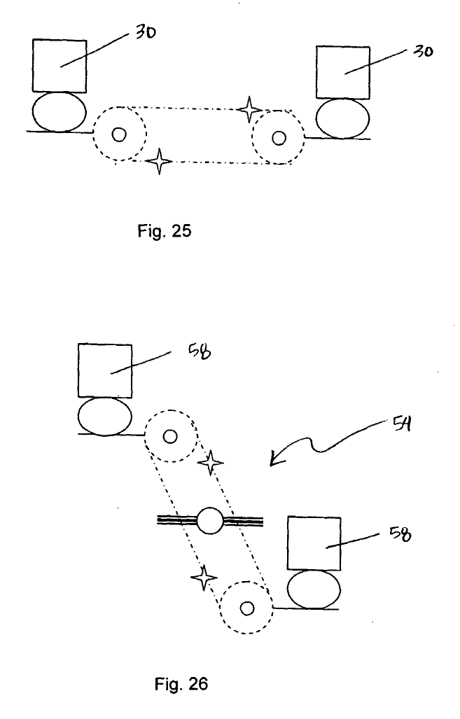

As shown in FIGS. 2, 8, and 10-13, the apparatus 10 can integrate exercise functions via a hand pedal assembly 52, having hand pedals 56, and a foot pedal assembly 54, having foot pedals 58. The pedal assemblies may be padded for additional comfort to the patient. Portions of the hand 52 and foot pedal assemblies may be located in the housing 14, but do not interfere with the transmission 40 as shown in FIG. 23. The pedal assemblies 52 and 54 are phase-shiftable via an idler to provide camel-walk or baby-crawl functions as shown in FIG. 9. FIGS. 25 and 26 show one embodiment in which, the foot support 30 converts to foot pedals for exercise pedal functions. Such embodiment also provides pedal set phase-shifting independently of an idler gear set.

FIGS. 10-13 and 16-21 show the apparatus 10 in operation. In use, one of the benefits of the present invention is that the face-support 24 maintains a patient's face parallel to the floor as the apparatus tilts from a substantially vertical orientation to a substantially horizontal orientation as shown in FIGS. 10-13 and 16-21. It serves to maintain the head firmly in a proper position with the center focus of eyes perpendicular to the floor, and the rest of the body optimally supported to remove strain from joints, the back, legs and arms.

The method and apparatus of the present invention makes use of a tilt mechanism to provide easy walk-on access. The housing 12 and support 16 tilt 90 degrees to allow walk-on access. By way of example, a regular operating orientation is shown in FIG. 10, while the partial tilt to vertical orientation is shown in FIG. 11. FIG. 12 illustrates full vertical mounting position and FIG. 13 illustrates the return to the operating position. An alternative embodiment as shown in FIGS. 20 and 21 is to tilt the housing to only 80 degrees from horizontal position, forcing the walk-on patient to lean forward against the housing to provide a balance bias forward in the same direction as the tilt to horizontal position. Consequently, this commits the user's weight in a forward direction providing greater vertical stability during the mounting and tilting procedure.

When the apparatus 10 is not in use, it can be stored in a substantially vertical orientation. This allows a patient to readily store the apparatus 10 in a closet or other storage facility. When a patient is ready to use the apparatus 10, the apparatus is adjusted to a substantially vertical position as show in FIGS. 12 and 20, so that a patient can readily walk onto the apparatus 10. As shown in FIG. 20, in one embodiment the apparatus is tilted at a 10° angle when in the resting position for easier walk-on access. When the apparatus 10 is in a resting position, a safety lock mechanism can be engaged to ensure that the device does not prematurely shift into an undesired position. In the event of mechanical failure of any component of the tilting mechanism, an automotive-type shock absorber is provided to assure a highly damped, gradual tilting of the mechanism to either the horizontal or vertical position dependent upon the prevalent weight distribution at the time. Once the patient mounts the apparatus 10, the patient's face is securely fixed in a face-down position in the aperture 25 of the face support 24, as shown in FIG. 20. The torso of the patient's body may be secured to the torso supports 26 and 28 using a restraint strap or belt as known in the art. Alternatively, guardrails may be provided alongside the torso area of the support 16 to prevent a patient from rolling off the apparatus. When the patient is ready to tilt into the horizontal orientation, the safety lock is disengaged, and the motor 42 is started thereby activating the motor driven sprocket 50 of the transmission 40, which in turn tilts the housing 14 and support 16 to any desired angle. The interrelated movements of the motor motive driven sprocket 50 in relation to the static sprockets 46 and 48 affecting the tilting motion are depicted in greater detail in FIGS. 14 and 15-21. Slow and steady motions are achieved through liberal use of Ultra High Molecular Weight Polyethylene (UHMW) to metal motion bearings throughout the apparatus, as well as low rotational and linear velocities.

In a preferred embodiment, the housing 14 and support 16 are tilted to a horizontal orientation as shown in FIG. 16. When the apparatus 10 is in complete horizontal orientation, a user's body weight is evenly supported on the proximal side of the body from head to feet across the support 16. One of the advantages of the present apparatus is that the support 16 adequately supports and distributes the weight of the user throughout the entire apparatus, preventing dead captive spaces to facilitate unobstructed breathing and comfortable sleeping positions. A small, slow speed silent ventilator 59 in the general area of the face support keeps a constant supply of fresh air circulated in the breathing area is shown in FIG. 16.

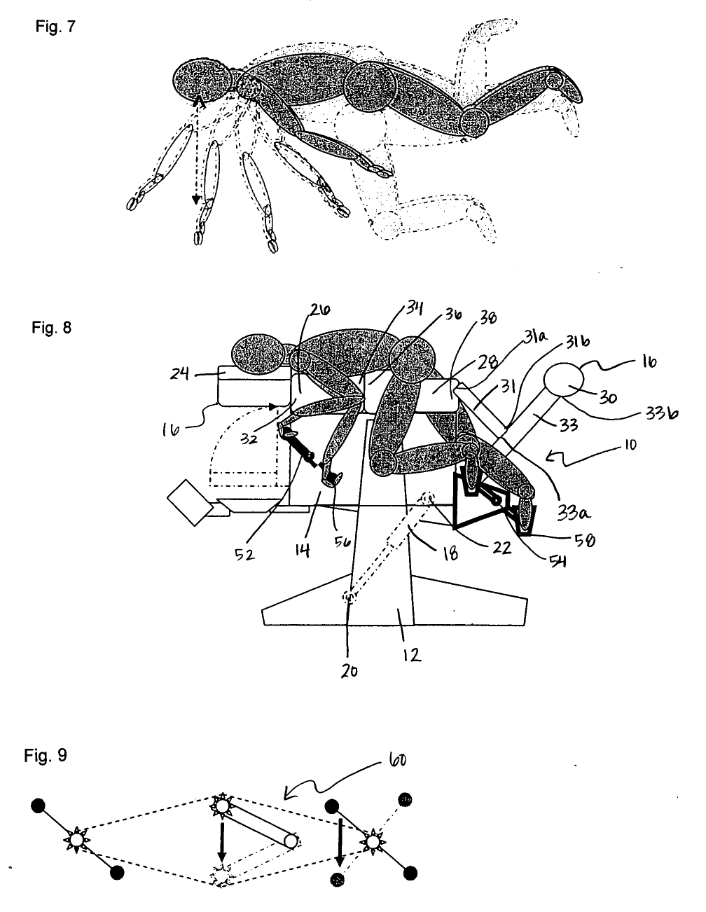

FIGS. 16-19 illustrate the present invention in which a user's head is firmly nested in a face-down position with the rest of the body located at an optimal and/or continuously variable angle or angles. When activated, the entire active apparatus may be adjusted to various angles to accommodate each individual user. Relative angles may be established between the (face-down) head and back with a pivot at the neck; between the lower back and thighs with a pivot at the hips; between the thighs and the lower leg with a pivot at the knees. The plurality of pivot connections between the various segments 24, 26, 28, and 30 of the support 16 can be continuously or intermittently set in motion while the user is in the horizontal orientation. As further shown in FIGS. 3-6, the supports on which the body is mounted permit continuous movement, undulations, of key joints and muscle groups while in a static resting position using a powered adjustable speed coordinated motion control to provide movement therapy. Such movements are further illustrated in FIGS. 7 and 16-19. The intermittent and/or continuous movement of the plurality of pivots allows various limbs to change angles preventing stiffness and fatigue to muscles and joints.

In another embodiment, the method and apparatus of the present invention may be in the form of an exercise center, as described above, providing a horizontal exercise bike for arms, legs, torso, neck, shoulders and buttocks, as illustrated in FIG. 8. The pedals provide a smooth rotary motion as opposed to an erratic reciprocal motion and allow a choice of motions of either infant crawling (or opposite arm and leg coordination on the same side) or camel-like crawling where both the left and right sides (arms and legs) move in unison. FIG. 9 illustrates a shifting pedal chain idler 60 from upper to lower position on the left changes front or rear pedal position phasing 90 degrees as in crawling or camel walk. Significantly, the shifting pedal chain idler 60 facilitates simultaneous changing of the foot and hand pedals. In another embodiment, the pedal phase shifting is accomplished in the pedal-foot rest shift, as shown in FIGS. 25 and 26.

The holistic face-down recovery center of this invention incorporates features making it easy to use, move, and maintain. For example, in another embodiment of the present invention, convenient slide-out removable trays provide cushioned supports for arms during periods of sleep in the face-down position. Additionally, a slide-in meal tray and a media center may be mounted to the housing 14 as shown in FIG. 2, that are easily accessible because the arms can reach to any position. The media center may include, but is not limited to, computers, audio CD players, videos (VHS and/or DVD) enhanced by surround sound, internet access, and radio, television, and mp3 connectivity. A 3-way mirror may also be attached to the housing so the patient may see forward while maintaining the correct face down position. The cushions adjust to size and contours of the body of the patient, as such, back pressure is minimal and sleep is comfortable. Additionally, a small motorized silent low-speed ventilator 59 may be mounted in proximity to the face-down support to continuously refresh the breathing area with fresh air. Optionally, an adjustable full color camera with zoom allows 360 degree vision via a laptop computer screen.

The method and apparatus of the present invention encourages patients to exercise, rest, sleep and even tap into their creativity. Its accessibility in either the horizontal or vertical positions, its adaptability for all bodies, and its functionality heartens the patient and eliminates monotony, stress, discomfort, and muscular atrophy. The present invention is applicable to other types and forms of highly constrictive or immobile recovery regimens for treatment for conditions other than those of the eyes such as, but not limited to, burn patients or joint and/or bone injuries.

While the specific embodiments have been illustrated and described, numerous modifications come to mind without significantly departing from the spirit of the invention, and the scope of protection is only limited by the scope of the accompanying claims.

What is claimed is:

1. A face down recovery apparatus for use in rehabilitation of patients, the recovery apparatus comprising:
a base;
a housing pivotally connected to the base;
an actuator coupled between the housing and the base and having a first end pivotally connected to the base and a second end pivotally connected to the housing;
a support contiguously connected to a first side of the housing for receiving a user;
wherein the apparatus is in a substantially vertical upright orientation when the support receives a user in a standing position and the user is secured to the support in the standing position in an unrestricted manner permitting mobility and as the housing is tilted into a horizontal position the user is positioned in a substantially horizontal orientation and as the user is tilted between the substantially vertical upright orientation and the substantially horizontal orientation the user's face is continuously maintained in a face-down position in a face support.

2. The apparatus of claim 1, wherein the support is adapted to adequately distribute the weight of a user's body to alleviate pressure from a user's head.

3. The apparatus of claim 1, wherein the support comprises the face support, an upper torso support, a lower torso support, and a foot support.

4. The apparatus of claim 3, wherein the support is padded.

5. The apparatus of claim 1, wherein the face support has an aperture for receiving a user's face.

6. The apparatus of claim 3, wherein the face support is coupled to a first end of the upper torso support via a drive-chain cantilevered movement to maintain the face support in a continuously parallel position.

7. The apparatus of claim 3, wherein the face support is independently adjustable relative to the upper torso support to permit mobility of the user.

8. The apparatus of claim 3, wherein a second end of the upper torso support being pivotally coupled to a first end of the lower torso support is independently adjustable relative to the face support and the lower torso support to permit mobility of the user.

9. The apparatus of claim 3, further comprising a first bracket wherein a second end of the lower torso support being pivotally coupled to a first end of the first bracket is independently adjustable relative to the lower torso support to permit mobility of the user.

10. The apparatus of claim 3, further comprising a second bracket wherein a second end of the first bracket being pivotally coupled to a first end of the second bracket is independently adjustable relative to the first bracket to permit mobility of the user.

11. The apparatus of claim 1, further comprising a small slow speed ventilator operably connected to the housing to facilitate air circulation.

12. The apparatus of claim 10, wherein the foot support being pivotally coupled to a second end of the second bracket is independently adjustable relative to the second bracket to permit mobility of the user.

13. The apparatus of claim 1, further comprising a transmission located within the housing operably coupled to the actuator for controlling tilting and/or undulation movements of the apparatus.

14. The apparatus of claim 1, further comprising a foot pedal assembly adjustably attached to a bottom region of the housing for exercising while in the face-down position.

15. The apparatus of claim 1, further comprising a hand pedal assembly adjustably attached to a top region of the housing for exercising while in the face-down position.

16. The apparatus of claim 1, further comprising a retractable tray attached to the top portion of the housing.

17. The apparatus of claim 1, further comprising a media center attached to the top portion of the housing.

18. The apparatus of claim 16, wherein the media center comprises a computer, an audio CD player, a video player, a DVD player, a computer, a television, or mp3 player.

19. A face down recovery apparatus for use in rehabilitation of patients, the recovery apparatus comprising:
a base;
a housing pivotally connected to the base;
an actuator coupled between the housing and the base and having a first end pivotally connected to the base and a second end pivotally connected to the housing;
a transmission located within the housing operably coupled to the actuator for controlling tilting and/or undulation movements of the apparatus;
a support contiguously connected to a first side of the housing for receiving a user, the support comprising a face support, an upper torso support, a lower torso support, and a foot support;
the face support being coupled to a first end of the upper torso support via a drive-chain cantilevered movement independently adjustable relative to the upper torso support;
a second end of the upper torso support being pivotally coupled to a first end of the lower torso support independently adjustable relative to the face support and the lower torso support;
a first bracket wherein a second end of the lower torso support being pivotally coupled to a first end of the first bracket independently adjustable relative to the lower torso support;
a second bracket wherein a second end of the first bracket being pivotally coupled to a first end of the second bracket independently adjustable relative to the first bracket;
the foot support being pivotally coupled to a second end of the second bracket independently adjustable relative to the second bracket;
the individual components of the support being pivotally connected to permit undulation movements as the apparatus is in a substantially horizontal orientation;
a foot pedal assembly adjustably attached to a bottom region of the housing;
a hand pedal assembly adjustably attached to a top region of the housing;
wherein the apparatus is in a substantially vertical upright orientation when the support receives the user in a standing position and the user is secured to the support in the standing position in an unrestricted manner permitting mobility and as the housing is tilted into a horizontal position the user is positioned in a substantially horizontal orientation and as the user is tilted between the substantially vertical upright orientation and the substantially horizontal orientation the user's face is continuously maintained in a face-down position in the face support.

20. The apparatus of claim 19, wherein the foot pedal assembly and the hand pedal assembly have an adjustable common chain idler to simultaneously change the positioning of the foot pedal and the hand pedal.

21. The apparatus of claim 19, further comprising a media center attached to the top portion of the housing.
